(19) United States
(12) Patent Application Publication
(10) Pub. No.: US 2013/0071203 A1
(43) Pub. Date: Mar. 21, 2013

(54) FASTENER RETENTION SYSTEM

(71) Applicant: James D. Hay, Milford, MI (US)

(72) Inventor: James D. Hay, Milford, MI (US)

(73) Assignee: GM GLOBAL TECHNOLOGY OPERATIONS LLC, Detroit, MI (US)

(21) Appl. No.: 13/238,123

(22) Filed: Sep. 21, 2011

(51) Int. Cl. F16B 13/04; F16B 43/00; F16B 13/00

(52) U.S. Cl. 411/111; 411/103

(57) ABSTRACT

An apparatus includes structure having a first surface and a second surface, and defining a hole having a first opening at the first surface and a second opening at the second surface. A first member extends into the hole through the first opening and defines a first aperture. A second member extends into the hole through the second opening and defines a second aperture. A threaded fastener is at least partially disposed within the first and second apertures, and is selectively rotatable about an axis. A retainer member is disposed within the first and second apertures and resists axial movement of the first and second members and the threaded fastener.

### TECHNICAL FIELD

The invention relates to fastener retention devices.

### BACKGROUND

When a first component that is sensitive to vibration must be mounted to a second component that produces vibrations, elastic isolators may be used in conjuction with a bolt or other threaded fastener to connect the first and second components. The elastic isolators act to absorb vibrations from the second component, thereby limiting the exposure of the first component to vibration.

### SUMMARY

An apparatus includes structure having a first surface and a second surface, and defining a hole having a first opening at the first surface and a second opening at the second surface. A first member extends into the hole through the first opening and defines a first aperture. A second member extends into the hole through the second opening and defines a second aperture. A threaded fastener is at least partially disposed within the first and second apertures, and is selectively rotatable about an axis. A retainer member is disposed within the first and second apertures and resists axial movement of the first and second members and the threaded fastener.

The retainer member thus retains the first member, the second member, and the third member together prior to, and during, attachment of the apparatus to another member.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic, cross-sectional, side view of a prefabricated assembly including a first member, a threaded fastener, compression limiters, a retainer member, and vibration damping isolators prior to attachment to a second member;

FIG. 2 is a schematic, perspective view of the retainer member of FIG. 1;

FIG. 3 is a schematic, cross-sectional, top view of one of the compression limiters, the retainer member, and the threaded fastener of FIG. 1; and

FIG. 4 is a schematic, cross-sectional, side view of the prefabricated assembly of FIG. 1 secured to the second member via the threaded fastener.

### DETAILED DESCRIPTION

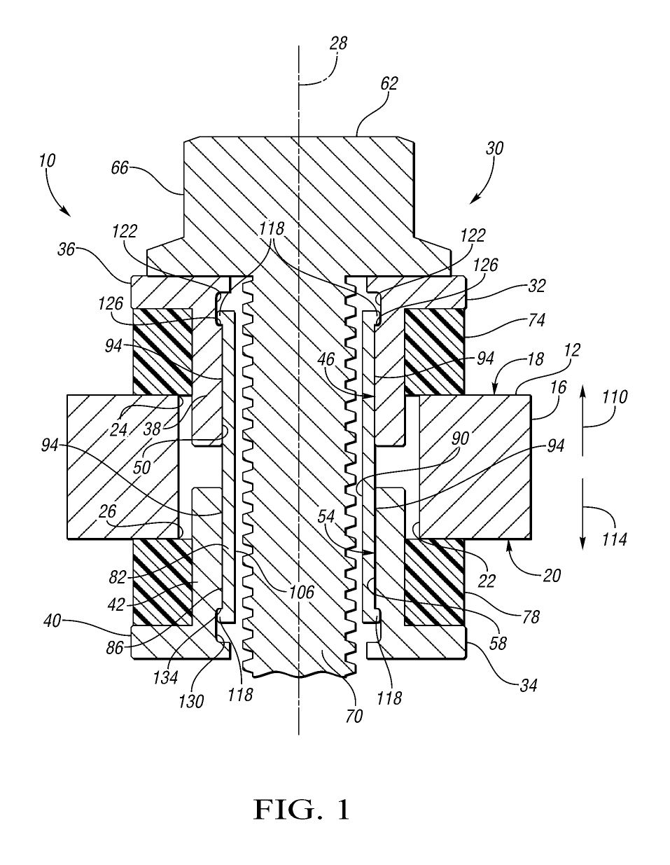

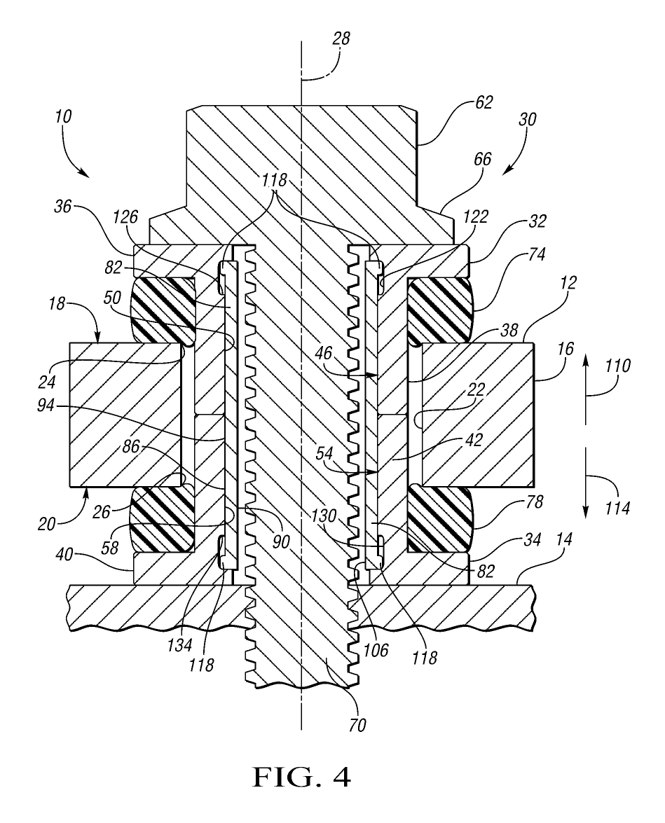

Referring to FIG. 1, a prefabricated assembly 10 includes a first member 12 that is configured for attachment to a second member (shown at 14 in FIG. 4). In the embodiment depicted, the prefabricated assembly 10 is a fuel rail assembly, the first member 12 is a bracket mounted to a fuel rail, and the second member 14 is an engine. The first member 12 includes structure 16 having a first surface 18 and a second surface 20. In the embodiment depicted, the first surface 18 and the second surface 20 face opposite directions. The structure 16 also defines a hole 22 that extends through the structure 16 and that is characterized by a first opening 24 at the first surface 18 and a second opening 26 at the second surface 20. In the embodiment depicted, hole 22 is a cylindrical bore centered along axis 28.

The assembly 10 also includes a fastener system 30 to secure the first member 12 to the second member 14. The fastener system 30 includes a first member, namely, a first compression limiter 32, which extends into the hole 22 through the first opening 24. The fastener system 30 also includes a second member, namely, a second compression limiter 34, which extends into the hole 22 through the second opening 26.

The first compression limiter 32 includes a first wide portion 36 and a first narrow portion 38. The second compression limiter 34 includes a second wide portion 40 and a second narrow portion 42. In the embodiment depicted, the first and second wide portions 36, 40 are generally cylindrical and are wider than the hole 22. More specifically, in the embodiment depicted, the first and second wide portions 36, 40 are annular and have an outer diameter that is larger than the diameter of the hole 22. Accordingly, the first and second wide portions 36, 40 are outside the hole 22. In the embodiment depicted, the first and second narrow portions 38, 42 are hollow cylinders and are narrower than the hole 22; more specifically, the outer diameters of the narrow portions 38, 42 are smaller than the diameter of hole 22. The narrow portions 38, 42 are at least partially disposed within the hole 22.

The first compression limiter 32 includes a first inner surface 46 that defines a first aperture 50. In the embodiment depicted, the inner surface 46, and, correspondingly, the aperture 50, is cylindrical. The aperture 50 extends through the first wide portion 36 and the first narrow portion 38 of the first compression limiter 32, and is centered along axis 28. The second compression limiter 34 includes a second inner surface 54 that defines a second aperture 58. In the embodiment depicted, the inner surface 54, and, correspondingly, the aperture 58, is cylindrical. The aperture 58 extends through the second wide portion 40 and the second narrow portion 42 of the second compression limiter 34, and is centered along axis 28.

The fastener system 30 includes a threaded fastener 62, which, in the embodiment depicted, is a bolt having a head portion 66 that is characterized by a generally polygonal cross-sectional shape. In the embodiment depicted, the head portion 66 is generally hexagonal, though other cross-sectional shapes may be employed within the scope of the claimed invention. The threaded fastener 62 also includes a threaded shank 70 that is rigidly connected to the head portion 66. The shank 70 of the threaded fastener 62 is at least partially disposed within the first and second apertures 50, 58. The threaded fastener 62 is selectively rotatable about the axis 28.

A first elastomeric isolator member 74 is disposed between the first surface 18 and the wide portion 36 of the first compression limiter 32. A second elastomeric isolator member 78 is disposed between the second surface 20 and the wide portion 40 of the second compression limiter 34. In the embodiment depicted, the elastomeric isolators 74, 78 are annular, with each elastomeric isolator member 74, 78 surrounding a respective narrow portion 38, 42. The elastomeric isolators 74, 78 isolate the first member 12 from vibrations transmitted from the second member 14 when the fastener system 30 connects the first member 12 to the second member 14.

The fastener system 30 also includes a retainer member 82 that is disposed within the first and second apertures 50, 58. The retainer member 82 holds the fastener system 30 together during transportation of the prefabricated assembly 10 and during connection of the first member 12 to the second member 14. In the absence of the retainer member 82, gravity may cause the separation of the fastener 62 and the first and second compression limiters 32, 34. The retainer member 82 holds the fastener system 30 together by resisting or limiting axial movement of the first and second compression limiters 32, 34 and the threaded fastener 62.

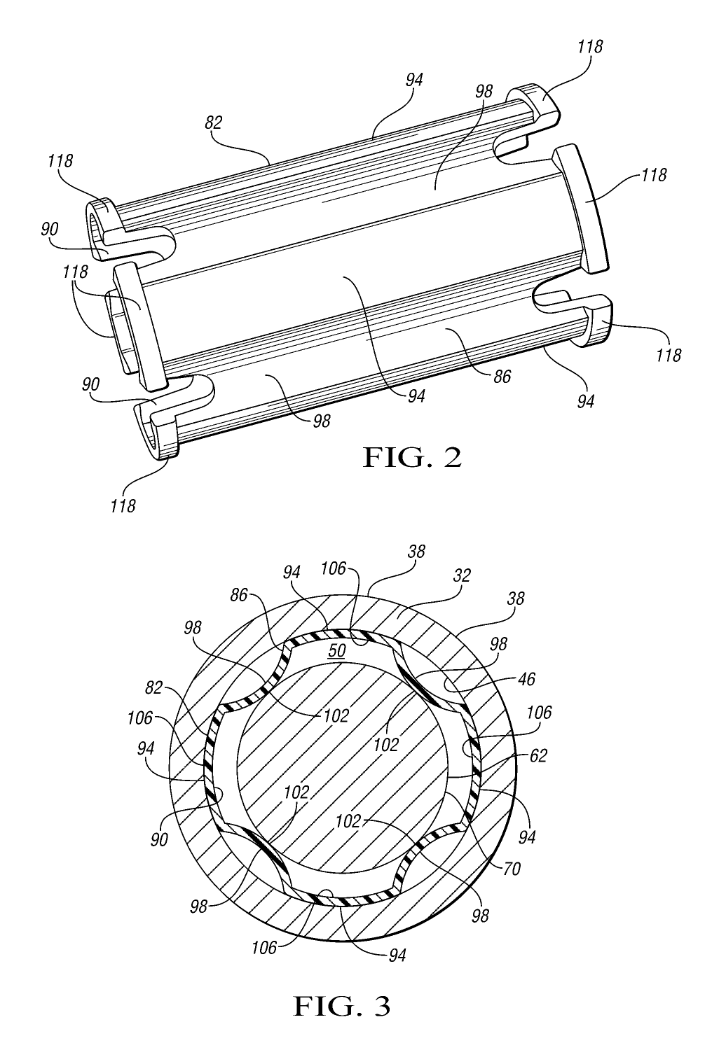

Referring to FIGS. 2 and 3, wherein like reference numbers refer to like components from FIG. 1, the retainer member 82 includes an outer surface 86 and inner surface 90. The outer surface 86 is characterized by a plurality of alternating convex portions 94 and concave portions 98. The convex portions 94 and the concave portions 98 extend axially along the length of the retainer member 82. In the embodiment depicted, the retainer member includes four concave portions 98 and four convex portions 94. The convex portions 94 are evenly spaced around the periphery of the retainer member 82; each concave portion 98 interconnects two of the convex portions 94.

The inner surface 90 is similarly characterized by a plurality of alternating convex portions 102 and concave portions 106. The convex portions 102 and the concave portions 106 extend axially along the length of the retainer member 82. In the embodiment depicted, the retainer member 82 includes four concave portions 106 and four convex portions 102. The convex portions 102 are evenly spaced around the periphery of the retainer member 82; each concave portion 106 interconnects two of the convex portions 102.

Referring specifically to FIG. 3, when the retainer member 82 is disposed within the first aperture 50 of the first compression limiter 32, each of the convex portions 94 of the outer surface 86 contacts the inner surface 46 of the first compression limiter 32. In the embodiment depicted, the second compression limiter 34 is substantially identical to the first compression limiter 32, and thus the interaction between the retainer member 82 and the second compression limiter 34 is substantially identical to the interaction between the retainer member 82 and the first compression limiter 32. More specifically, each of the convex portions 94 of the outer surface 86 contacts the inner surface 54 of the second compression limiter 34.

The interaction between the convex portions 94 and the inner surfaces 46, 54 generally restricts movement of the first and second compression limiters 32, 34 (relative to each other) to axial movement (i.e., parallel to axis 28) and, optionally, to rotation about axis 28. Thus, referring again to FIG. 1, the convex portions 94 substantially limit translation of the first and second compression limiters 32, 34 to a first axial direction 110 and a second axial direction 114.

Referring to FIGS. 1 and 2, the retainer member 82 includes, at each axial end, a plurality of radially-extending protuberances, i.e., projections 118, that extend radially outward from the convex portions 94 of the outer surface 86. Referring specifically to FIG. 1, the first inner surface 46 of the first compression limiter 32 defines a first concavity 122. The first concavity 122 in the embodiment depicted is an annular groove. A first radially-extending lip 126 at least partially defines the concavity 122. Similarly, the second inner surface 54 of the second compression limiter 34 defines a second concavity 130. The second concavity 130 in the embodiment depicted is an annular groove. A second radially-extending lip 134 at least partially defines the concavity 130. The projections 118 at one end of the retainer member 82 extend radially into the first concavity 122. The projections 118 at the other end of the retainer member 82 extend into the second concavity 130.

The projections 118 that are disposed within the first concavity 122 and the first lip 126 are positioned so that contact between the projections 118 and the first lip 126 limits movement of the first compression limiter 32 in the first axial direction 110. Similarly, the projections 118 that are disposed within the second concavity 130 and the second lip 134 are positioned so that contact between the projections 118 and the second lip 134 limits movement of the second compression limiter 34 in the second axial direction 114.

More specifically, as shown in FIG. 1, the first lip 126 contacts projections 118; a force urging the first compression limiter 32 in the first direction 110 results in the projections 118 exerting a reaction force on the lip 126 having at least a component in the second direction 114, thereby resisting movement of the first compression limiter 32 in the first direction 110. Similarly, the second lip 134 contacts projections 118; a force urging the second compression limiter 34 in the second direction 114 results in the projections 118 exerting a reaction force on the lip 134 having at least a component in the first direction 110, thereby resisting movement of the second compression limiter 34 in the second direction 114.

As shown in FIG. 1, prior to attachment of the prefabricated assembly 10 to the second member 14, the first and second compression limiters 32, 34 are spaced apart from one another such that they form a gap therebetween. The elastomeric isolator members 74, 78 are uncompressed. Referring to FIG. 4, wherein like reference numbers refer to like components from FIGS. 1-3, when the threaded fastener 62 is rotated about axis 28 so that the threads of shank 70 engage the threads of a hole in the second member 14, an axially compressive force is applied to the first and second compression limiters 32, 34, which is transferred to the elastomeric isolator members 74, 78.

The compressibility of the members 74, 78 results in axial movement of the compression limiters 32, 34 toward one another until they contact one another, as shown in FIG. 4. To accommodate this axial movement of the first and second compression limiters 32, 34, the first and second concavities 122, 130 are sufficiently dimensioned to permit the first and second compression limiters 32, 34 to contact one another while the projections 118 remain within the first concavity 122 and the second concavity 130. That is, the cavities 122, 130 extend sufficiently axially such that there is no intereference between the projections 118 and the compression limiters 32, 34 that would limit movement of the compression limiters 32, 34 from their positions in FIG. 1 to their positions in FIG. 4.

Referring again to FIG. 3, the retainer member 82 resists axial movement of the threaded fastener 62 through frictional resistance applied by the convex portions 102 of the inner surface 90. In the embodiment depicted, the fastener system 30 is assembled by inserting the retainer member 82 into the first aperture 50 until the projections 118 on one end of the retainer member 82 enter the first concavity 122 in a snap-fit configuration, and inserting the retainer member 82 into the second aperture 58 until the projections 118 on the other end of the retainer member 82 enter the second concavity 130 in a snap-fit configuration.

The threaded fastener 62 is then inserted into the retainer member 82; as the threaded fastener 62 is inserted, the shank 70 exerts a radially-outward force on the convex portions 102, thereby causing some elastic deformation of the retainer member 82. Accordingly, the convex portions 102 exert a radially-inward spring force on the shank 70, which increases the frictional resistance between the shank 70 and the convex portions 102.

The retainer member 82 in the embodiment depicted has a low compressive yield, and thus does not hinder the tightening of the threaded fastener 62 to achieve the required clamp load of the bolt-to-isolator grommet-to-engine interface. In one embodiment, the retainer 82 is made of thermoplastic elastomer material. The retainer member 82 acts independently of the fastener 62 to retain the compression limiters 32, 34 with respect to each other, and thus also to retain the isolator members 74, 78, which are trapped between the structure 16 and the wide portions 36, 40. Accordingly, the compression limiters 32, 34 and the elastomeric isolator members 74, 78 will still remain together as assembled even if the threaded fastener 62 is removed or inadvertently bumped or jostled.

While the best modes for carrying out the invention have been described in detail, those familiar with the art to which this invention relates will recognize various alternative designs and embodiments for practicing the invention within the scope of the appended claims.

1. An apparatus comprising:
structure having a first surface and a second surface, and defining a hole having a first opening at the first surface and a second opening at the second surface;
a first member extending into the hole through the first opening and defining a first aperture;
a second member extending into the hole through the second opening and defining a second aperture;
a threaded fastener being at least partially disposed within the first and second apertures, and being selectively rotatable about an axis; and
a retainer member being disposed within the first and second apertures and resisting axial movement of the first and second members and the threaded fastener.

2. The apparatus of claim 1, wherein the first member includes a radially-extending first lip;
wherein the second member includes a radially-extending second lip;
wherein the retainer member includes a radially-extending first protuberance and a radially-extending second protuberance; and
wherein the first protuberance and the first lip are positioned so that contact between the first protuberance and the first lip limits movement of the first member in a first axial direction; and
wherein the second protuberance and the second lip are positioned so that contact between the second protuberance and the second lip limits movement of the second member in a second axial direction.

3. The apparatus of claim 2, wherein the first member includes a first inner surface that defines the first aperture;
wherein the second member includes a second inner surface that defines the second aperture;
wherein the first inner surface is characterized by a first concavity;
wherein the second inner surface is characterized by a second concavity;
wherein the first protuberance is at least partially disposed within the first concavity; and
wherein the second protuberance is at least partially disposed within the second concavity.

4. The apparatus of claim 3, wherein the first lip partially defines the first concavity;
wherein the second lip partially defines the second concavity;
wherein the first and second concavities are sufficiently dimensioned to permit the first and second members to contact one another while the first protuberance remains within the first concavity and the second protuberance remains within the second concavity.

5. The apparatus of claim 2, wherein the retention member includes a third inner surface that contacts the threaded fastener.

6. The apparatus of claim 5, wherein the third inner surface includes a plurality of convex portions that contact the threaded fastener.

7. The apparatus of claim 2, wherein the first member includes a first portion outside the hole;
wherein the second member includes a second portion outside the hole; and
wherein the first and second portions are wider than the hole.

8. The apparatus of claim 7, further comprising a first elastomeric member being at least partially disposed between the first portion and the first surface; and
a second elastomeric member being at least partially disposed between the second portion and the second surface.

9. An apparatus comprising:
a fuel rail assembly including a bracket having a first surface and a second surface, and defining a hole having a first opening at the first surface and a second opening at the second surface;
a first member extending into the hole through the first opening and defining a first aperture;
a second member extending into the hole through the second opening and defining a second aperture;
a threaded fastener being at least partially disposed within the first and second apertures, and being selectively rotatable about an axis; and
a retainer member being disposed within the first and second apertures and resisting axial movement of the first and second members and the threaded fastener.

10. The apparatus of claim 9, wherein the first member includes a radially-extending first lip;
wherein the second member includes a radially-extending second lip;
wherein the retainer member includes a radially-extending first protuberance and a radially-extending second protuberance; and
wherein the first protuberance and the first lip are positioned so that contact between the first protuberance and the first lip limits movement of the first member in a first axial direction; and
wherein the second protuberance and the second lip are positioned so that contact between the second protuberance and the second lip limits movement of the second member in a second axial direction.

11. The apparatus of claim 10, wherein the first member includes a first inner surface that defines the first aperture;
wherein the second member includes a second inner surface that defines the second aperture;
wherein the first inner surface is characterized by a first concavity;
wherein the second inner surface is characterized by a second concavity;
wherein the first protuberance is at least partially disposed within the first concavity; and
wherein the second protuberance is at least partially disposed within the second concavity.

12. The apparatus of claim 11, wherein the first lip partially defines the first concavity;
wherein the second lip partially defines the second concavity;
wherein the first and second concavities are sufficiently dimensioned to permit the first and second members to contact one another while the first protuberance remains within the first concavity and the second protuberance remains within the second concavity.

13. The apparatus of claim 10, wherein the retention member includes a third inner surface that contacts the threaded fastener.

14. The apparatus of claim 13, wherein the third inner surface includes a plurality of convex portions that contact the threaded fastener.

15. The apparatus of claim 10, wherein the first member includes a first portion outside the hole;
wherein the second member includes a second portion outside the hole; and
wherein the first and second portions are wider than the hole.

16. The apparatus of claim 15, further comprising a first elastomeric member being at least partially disposed between the first portion and the first surface; and
a second elastomeric member being at least partially disposed between the second portion and the second surface.
